(19) United States
(12) Patent Application Publication
(10) Pub. No.: US 2008/0309888 A1
(43) Pub. Date: Dec. 18, 2008

(54) Stage projector structure

(75) Inventor: Gabriele Giorgi, Gabicce Mare PU (IT)

Correspondence Address: COHEN, PONTANI, LIEBERMAN & PAVANE LLP, 551 FIFTH AVENUE, SUITE 1210, NEW YORK, NY, 10176, US

(73) Assignee: SGM Technology For Lighting S.p.A., Tavullia PU (IT)

(21) Appl. No.: 12/154,506

(22) Filed: May 23, 2008

(30) Foreign Application Priority Data
May 23, 2007 (IT) PS2007 A 000020

(51) Int. Cl. G03B 21/28; G03B 21/20

(52) U.S. Cl. 353/81; 353/99

(57) ABSTRACT

A projector structure, such as a stage use projector, is provided for managing light projection and suitable for replacing a “Gobo” device. The projector structure has a digital micromirror device (DMD) and a refraction and/or reflection device for circulating light beams (R) around the digital micromirror device and maintaining the coaxiality between the light source and the projection lenses.

### BACKGROUND OF THE INVENTION

1. Field of the Invention

The invention relates generally to a projector structure, and particularly a projector structure for stage use, for managing light projection of light beams.

2. Description of the Related Art

Projectors, especially those for stage use, are typically provided with mechanical devices, such as “Gobo” devices (an acronym of “goes before optics”), for manipulating the light beams generated by the light source. Such “Gobo” devices can include perforated masks arranged between the light source and the projection lenses. The masks usually have a discoid shape and are suitable for creating patterns with the projected light and for partly screening the projected light. “Gobo” devices can have a plurality of such masks that are automatically interchangeable, thereby allowing the projector to create various patterns.

Electronic light beam manipulation technology, such as digital micromirror devices (DMD), is known. In a typical digital micromirror device, one of its surfaces includes a plurality of reflecting elements, which can have infinitesimal dimensions. Each of these reflecting elements can be autonomously rotated based on the electrostatic attraction produced by the tension difference developed between an individual micromirror and a respective underlying memory cell, so that each micromirror can reflect light beams in multiple directions. By selectively rotating a part of the plurality of micromirrors in the digital micromirror device, which can be appropriately defined by its location and number, different effects of pattern and chromaticity can be achieved.

The use of digital micromirror devices in various projector applications is known. However, digital micromirror devices have not been satisfactorily applied to stage use projectors because the geometry of the light beam management system for digital micromirror devices imposes configurations that are not suited for stage projectors or for the quick variation of light beam orientation.

### SUMMARY OF THE INVENTION

An object of the present invention is to provide a stage use projector using a digital micromirror device wherein the geometry is suitable for the usual shapes of stage projectors and being adaptable for quick directional movement of light beams.

Another object of the present invention is to provide a stage use projector with a digital micromirror device that is compatible with the interchangeability of “Gobo” devices in the projector.

Yet a further object of the present invention is to achieve the above objects through a simple and effective solution, with safe operation and relatively low cost in consideration of the results achieved in practice.

These and other objects are met by an embodiment of the present invention including a projector structure for stage use having an interchangeable module for managing light projection and suitable for replacing a “Gobo” device. The interchangeable module includes a digital micromirror device (DMD) and a circulation device, such as a refraction and/or reflection device, for circulating light beams (R) around the digital micromirror device (DMD). The interchangeable module allows its outgoing light beams to be coaxial with the light beams (R) from the light source.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the projector structure according to the present invention, will appear more clearly from the following detailed description of preferred but non-exclusive embodiments thereof, illustrated by way of non-limiting examples in the annexed three drawings, wherein:

FIG. 1 is a schematic view of a projector structure according to the present invention illustrating light beams in one reflection direction of the digital micromirror device;

FIG. 2 is a similar view to FIG. 1 illustrating light beams in another reflection direction of the digital micromirror device; and

FIG. 3 is a schematic view of an isolated digital micromirror device module for use in the projector structure according to the present invention.

### DETAILED DESCRIPTION OF THE PRESENTLY PREFERRED EMBODIMENTS

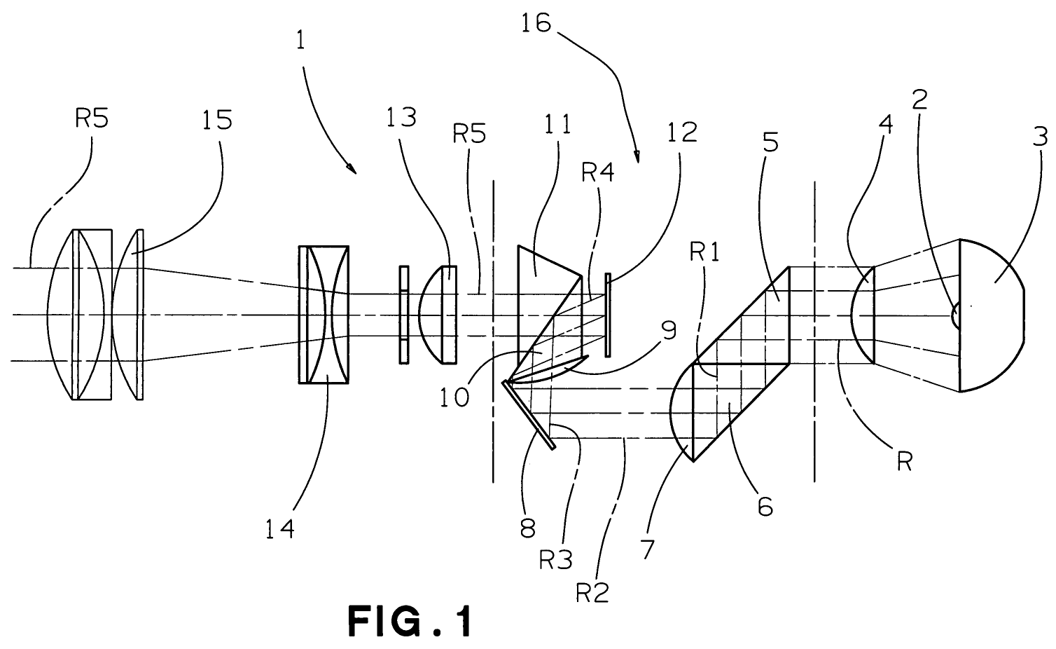

FIG. 1 shows a stage projector 1 according to an embodiment of the present invention and including a light source 2 with a discharge lamp. The light source 2 is placed next to a parabola reflector 3 and emits a bundle of light beams R along an emission axis. The light beams R are focused on a first lens 4.

A module 16 is arranged downstream of the first lens 4, including the following components in a sequence as illustrated in FIG. 1: a first optical prism 5 and a second optical prism 6 facing each other and twinned in a pair; a second lens 7; a conventional mirror 8 placed in an inclined position; a third lens 9; a third optical prism 10 and a fourth optical prism 11 facing each other and twinned in a pair; and a digital micromirror device 12, which can be connected to an appropriate electronic processor equipped with suitable software. The stage projector further comprises a series of projection lenses 13, 14 and 15 arranged downstream of the module 16.

The above components are positioned and oriented so that beyond the first lens 4, the light beams R are subjected to a circulation path relative to the emission axis. In the example of FIG. 1, the light beams R undergo a first deviation and result in first deviated light beams R1 along an axis substantially perpendicular to the emission axis of the light beams R. In this example, the light beams R pass through the first optical prism 5 and are refracted thereby to form the refracted light beams R1.

The light beams R1 then pass through the second optical prism 6 and undergo a second deviation by refraction resulting in second deviated light beams R2 along an axis substantially parallel to the emission axis of the light beams R. The light beams R2 next reach the inclined mirror 8 and are subjected to a third deviation by reflection resulting in third deviated light beams R3 along an axis substantially perpendicular to the emission axis of the light beams R.

The third deviated light beams R3 are subjected to a fourth deviation to form fourth deviated light beams R4, which are oriented on an axis substantially coaxial to the emission axis of the light beams R. In the example of FIG. 1, the third deviated light beams R3 pass through the third optical prism 10 and result in refracted light beams R4.

The fourth deviated light beams R4 are directed onto a digital micromirror device 12, which is positioned with its reflecting surface facing away from the light source 2 and is coaxially oriented thereto. In the normal orientation, the digital micromirror device 12 reflects light beams R5, which are coaxial to the emission axis of the light beams R from the light source 2. The bundle of light beams R5 then pass through the fourth optical prism 11 and the optics 13, 14 and 15 and undergo a projection to the exterior, without any further deviation, for the projector's own functions.

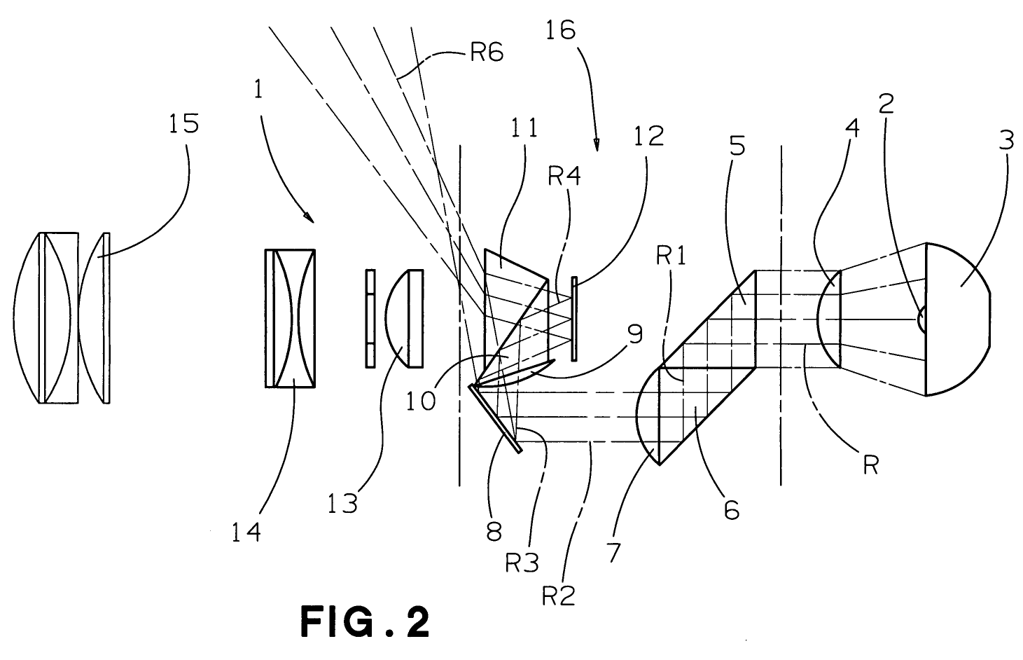

FIG. 2 shows that all or part of the light beams R5, crossing the fourth prism 11, can be deviated as light beams R6, which will not undergo a projection to the exterior. For example, the digital micromirror device 12 can be electronically intervened in a known manner, such as by using an electronic processor (not shown) provided with appropriate software, to change the orientation of all or part of the digital micromirror device 12. In one example, all or part of the light beams reflected by the digital micromirror device 12, after being refracted by the fourth prism 11, are directed towards opaque areas or otherwise away from the projection lenses 13, 14 and 15. The refracted light beams R6 do not undergo a projection to the exterior.

By selectively rotating a part of the plurality of mirrors in the digital micromirror device 12, appropriately defined by location, number and color, a portion of the light beams can be conveyed outwards while other portion of the light beams are opacified, i.e., directed to opaque areas or otherwise away from projection lenses 13, 14 and 15. The bundle of light beams R5 projected outwardly can thus achieve various effects of patterns and chromaticity.

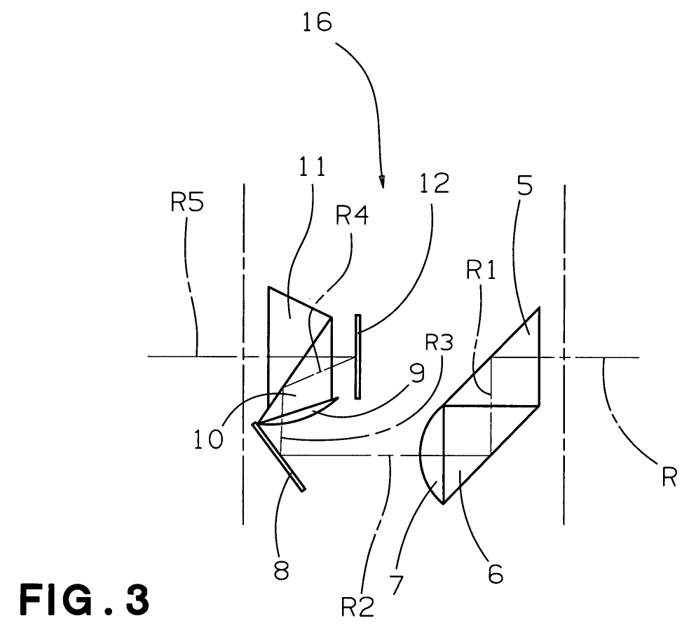

The module 16 including the circulation device (e.g., optical components 5, 6, 8, 10, 11) and the digital micromirror device 12 can be formed as a separate independent unit, as illustrated in FIG. 3. The module 16 can be removable and interchangeable with a “Gobo” device of a known type. For example, the module 16 can be formed to be appropriately supported in a projector by similar means that “Gobo” devices are arranged on directrix of the bundle of the light beams R without any circulations in a conventional projector.

As the circulation device (e.g., optical components 5, 6, 8, 10, 11) of the light beams R around the digital micromirror device 12 maintains coaxiality between the light source 2 and the projection lenses 13, 14, 15, the light source 2 can comprise a discharge lamp having increased discharge arc, i.e., greater distance between the electrodes.

As one skilled in the art will appreciate, discharge lamps with conventional discharge arc dimensions (i.e., reduced distance between the electrodes), are not functional for stage use projectors, as they are not adapted for sudden movements often imposed on such devices, to vary orientation of the light beams on quickly moving subjects or the like.

Lamps with a discharge arc of increased dimensions are better suited for the strains that stage use projectors are subjected to. The circulation device according to the present invention allows the use of such lamps with discharge arc of increased dimensions.

As one skilled in the art will appreciate, additional and/or alternative embodiments still fall within the solution concept implied in the embodiments illustrated above and within the scope of claims below. The projector structure according to the present invention can be embodied in various other technical and mechanical equivalents, such as other forms of integrated or modular devices, while the shapes of the corresponding components may be changed suitably for that purpose.

In particular, the circulation device circulates light beams around the digital micromirror device 12, which faces away from the light source. The circulation device allows the light beams to be directed to the digital micromirror device 12 and reflected thereby forming reflected light beams coaxially to the light beams R emitted from the light source 2. Such a circulation device can alternately be achieved with optical components of other kinds and appropriate types. For example, the optical components can be structured, shaped and positioned in various other manners suitable for the purpose.

Based on the above detailed description of preferred and alternative embodiments, the projector structure according to the present invention has the advantages corresponding to the attainment of the intended purposes as well as others. The projector structure provides a functional, multipurpose and inexpensive solution for applying the advantageous digital micromirror devices technology to known structures of stage projectors, while setting up conventional projectors suitable for digital technique, affording modulation structures for both manufacturers and operators, as well as standardizing components, except for those required to change traditional technology into digital technology.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A projector structure comprising:
a light source for generating light beams (R) along an emission axis;
a digital micromirror device managing light projection from the projector structure;
at least one of refraction and reflection elements for circulating the light beams (R) around said digital micromirror device; and
one or more projection lenses;
wherein the light source and the one or more projection lenses are coaxial.

2. The projector structure of claim 1, wherein the digital micromirror device and the at least one of refraction and reflection elements form an interchangeable module for replacing a “Gobo” device.

3. The projector structure of claim 1, wherein the at least one of refraction and reflection elements comprise a prism and mirror system.

4. The projector structure of claim 1, wherein the at least one of refraction and reflection elements form a circulation unit and subject the light beams (R) to a first deviation substantially perpendicular to the emission axis, a second deviation substantially parallel to the emission axis, a third deviation substantially perpendicular to the emission axis, and a fourth deviation substantially in the direction of the emission axis and towards the digital micromirror device.

5. The projector structure of claim 1, wherein light beams reflected outward from the digital mirror device are substantially coaxial to the light beams (R) generated by the light source.

6. The projector structure of claim 1, wherein the digital micromirror device comprises a reflecting surface facing away from the light beams (R) generated by the light source.

7. The projector structure of claim 1, wherein the at least one of refraction and reflection elements comprise:
a first optical prism and a second optical prism facing each other and twinned in a pair;
a mirror placed in an inclined position for directing the light beams towards the digital micromirror device; and
a third optical prism and a fourth optical prism facing toward each other and twinned in a pair.

8. The projector structure of claim 7, wherein:
the first optical prism deviates the light beams (R) in a direction substantially perpendicular to the emission axis to form first deviated light beams (R1);
the second optical prism deviates the first deviated light beams (R1) in a direction substantially parallel to the emission axis to form second deviated light beams (R2);
the inclined mirror deviates the second deviated light beams (R2) in a direction substantially perpendicular to the emission axis to form third deviated light beams (R3); and
the third optical prism and the fourth optical prism deviate the third deviated light beams (R3) in a direction substantially coaxial to the emission axis (R) and towards the digital micromirror device.

9. The projector structure of claim 1, wherein the digital micromirror device has a normal orientation, at which reflected light beams travel along an axis substantially coaxial with the emission axis of the light beam (R).

10. The projector structure of claim 1, wherein the digital micromirror device has an inclined orientation, at which reflected light beams are directed towards an opaque area in the projector structure.

11. The projector structure of claim 4, wherein the digital micromirror device and the circulation unit form an interchangeable module suitable for replacing a “Gobo” device.

12. The projector structure of claim 1 further comprising a parabola reflector, wherein the light source is positioned in the parabola reflector and comprises a discharge lamp having an increased discharge arc.

13. The projector structure of claim 1, wherein the projector structure is a stage projector.

14. A projector structure comprising:
a light source for generating light beams (R) along an emission axis;
a digital micromirror device managing light projection for the projector structure; and
a circulation device for circulating the light beams (R) around said digital micromirror device;
wherein outgoing light beams exiting the projector structure are substantially coaxial with the light beams (R) generated by the light source generated by the light source.

15. The projector structure of claim 14, wherein the digital micromirror device and the at least one of refraction and reflection elements form an interchangeable module for replacing a “Gobo” device.

16. The projector structure of claim 14 further comprising one or more projection lenses, wherein the light source and the one or more projection lenses are coaxial.

17. A digital micromirror device module for use in a projector, the module comprising:
a digital micromirror device managing light projection for the projector structure; and
a circulation device for circulating the light beams (R) around the digital micromirror device;
wherein outgoing light beams exiting the module are substantially coaxial with the incoming light beams (R).

18. The digital micromirror device module of claim 17, wherein the digital micromirror device has a reflecting portion facing away from the incoming light beams (R).

19. The digital micromirror device module of claim 17, wherein light beams reflected from the reflecting position are coaxial with the incoming light beams (R).

20. The digital micromirror device module of claim 17, wherein the circulation device comprises:
a first optical prism and a second optical prism twinned in a pair;
a mirror in an inclined position for directing the light beams towards the digital micromirror device; and
a third optical prism and a fourth optical prism twinned in a pair.
